(19) United States
(12) Patent Application Publication
(10) Pub. No.: US 2023/0049999 A1
(43) Pub. Date: Feb. 16, 2023

(54) AVAILABILITY CALCULATION DEVICE AND AVAILABILITYCALCULATION METHOD

(71) Applicant: NEC Corporation, Tokyo (JP)

(72) Inventor: Naoki Noguchi, Tokyo (JP)

(73) Assignee: NEC Corporation, Tokyo (JP)

(21) Appl. No.: 17/874,445

(22) Filed: Jul. 27, 2022

(30) Foreign Application Priority Data
Aug. 12, 2021 (JP) 2021-131602

(51) Int. Cl. H04L 43/0805; H04L 43/0894

(52) U.S. Cl. CPC H04L 43/0805; H04L 43/0894

(57) ABSTRACT

An availability calculation device includes a bandwidth notification information storing unit that stores received bandwidth notification information for a certain period, and an availability calculation unit that calculates an availability for each bandwidth of a wireless link by using the bandwidth notification information stored in the bandwidth notification information storing unit.

This application is based upon and claims the benefit of priority from Japanese Patent Application No. 2021-131602, filed on Aug. 12, 2021, the disclosure of which is incorporated herein in its entirety by reference.

### TECHNICAL FIELD

The present invention relates to an availability calculation device and an availability calculation method, and particularly relates to calculation of an index used to determine a transfer destination of traffic in a communication network including a plurality of communication paths formed by a plurality of communication devices.

### BACKGROUND ART

There is link aggregation communication using a plurality of communication paths simultaneously in order to increase a transfer capacity. The link aggregation communication is also referred to as multi-link communication. International Publication No. WO2018/179922 relates to such link aggregation communication using a plurality of communication paths simultaneously, and proposes that allocation to a suitable communication path is performed in link aggregation communication using a plurality of communication paths simultaneously.

### Background 1

In a case where a communication network is Ethernet (Registered Trademark), the communication network is mainly configured by a combination of a Layer 3 (L3) communication device, a Layer 2 (L2) communication device, and a wired link/wireless link. Generally, a wireless link is easier to install than a wired link, but on the other hand, it is difficult to secure a large communication band. In order to secure a larger communication band in the wireless link, it is effective to increase the carrier frequency used for the wireless link. However, on the other hand, the higher the carrier frequency, the lower the robustness against environmental changes, and thus the lower the quality as a link. Therefore, in a case where different carrier frequencies are used in a plurality of wireless links, it can be said that quality of the wireless links is also different.

### Background 2

As an existing technique, there is a technique of providing a notification of a band nominal value and a band current value of a wireless link between communication devices in a network. For example, as means for providing a notification of band information, there is means defined in ITU-T Recommendations or the like. For example, in the ITU-T G.8013/Y.1731 Recommendations, the Internet <https://www.itu.int/rec/T-REC-G.8013-201508-I/en> (Non-Patent Literature 1 [NPL1]), notification means of band information called Ethernet Bandwidth Notification (ETH-BN) is defined as one function of Ethernet Operations, Administration, and Maintenance (OAM) (here, “Ethernet” is a Registered Trademark).

### Background 3

In a communication network, a service level agreement (SLA) between a provider and a user may be defined. In the SLA, it is specified how much the provider guarantees a quality index such as a communication speed and a use stopping time in the communication network to the user. The provider builds and operates a communication network in such a way as to be able to satisfy a high-level SLA. The provider can mark traffic important to satisfy a high-level SLA with a high priority. Traffic marked with a high priority is required to be transferred more preferentially than other traffic in such a way as not to generate a loss.

Japanese Patent Application Laid-open No. 2019-161427 (JP2019-161427A) relates to switching of a communication path of a communication network including a plurality of communication paths formed by a plurality of communication devices. JP2019-161427A proposes a technique for ascertaining a state of a communication band of a wireless transfer path to a transfer destination and determining whether to switch a communication path of the transfer destination from a main line to ta backup line according to a priority of a main signal to be transferred.

However, the method of determining a transfer destination of the traffic according to the above background art has the following issues.

A case where a communication network is Ethernet will be described below as an example. In a case of transferring traffic marked with a high priority, the L3 communication device is required to transfer the traffic to a path with as high reliability as possible (availability) in such a way as not to generate a loss. However, the L3 communication device cannot recognize an availability of a wireless link of the L2 wireless communication device.

Therefore, in a case where there is a plurality of wireless links as candidates of a transfer path from the L3 communication device, particularly in a case where carrier frequencies of the wireless links are different, the L3 communication device transfers the traffic without considering an availability of a wireless link although there is a high probability that the availabilities of the wireless links may be different. Thus, there is concern that the L3 communication device transfers the high priority traffic to a wireless link having a relatively low availability, and a loss of the high priority traffic occurs.

In WO2018/179922 and JP2019-161427A, a solution to the above issue that the L3 communication device transfers high priority traffic to a wireless link having a relatively low availability is not proposed.

An object of the present invention is to provide an availability calculation device and an availability calculation method capable of transferring traffic to a communication path of a communication network including a plurality of communication paths formed by a plurality of communication devices in consideration of an availability of a wireless link.

### SUMMARY

In order to achieve the above object, according to the present invention, there is provided an availability calculation device including:
a bandwidth notification information storing unit that stores received bandwidth notification information for a certain period; and
an availability calculation unit that calculates an availability for each bandwidth of a wireless link by using the bandwidth notification information stored in the bandwidth notification information storing unit.

According to the present invention, there is provided a communication device included in a communication network including:
a plurality of communication paths formed by a plurality of communication devices, the communication device including the availability calculation device, in which
the communication device determines a transfer destination of traffic in consideration of information regarding the derived highly reliable bandwidth.

According to the present invention, there is provided a communication network including a plurality of communication paths formed by a plurality of communication devices, the communication network including:

the communication device having the above feature.

According to the present invention, there is provided an availability calculation method including:
storing received bandwidth notification information for a certain period; and
calculating an availability for each bandwidth of a wireless link by using the stored bandwidth notification information.

According to the present invention, there is provided a determination method for determining a transfer destination of traffic in a communication network including a plurality of communication paths formed by a plurality of communication devices, the determination method including:
determining the transfer destination of the traffic in consideration of information regarding a highly reliable bandwidth derived by using the availability calculation method.

According to the present invention, it is possible to transfer traffic in consideration of an availability of a wireless link in a communication path of a communication network including a plurality of communication paths formed by a plurality of communication devices.

### BRIEF DESCRIPTION OF THE DRAWINGS

Exemplary features and advantages of the present invention will become apparent from the following detailed description when taken with the accompanying drawings in which:

FIG. 1 is a block diagram for describing an availability calculation device according to an example embodiment of a superordinate concept of the present invention;

FIG. 2 is a block diagram for describing an example of a communication network including a plurality of communication paths formed by a plurality of communication devices to which the availability calculation device in FIG. 1 is applied;

FIG. 3 is a block diagram for describing an example of a communication network including a plurality of communication paths formed by a plurality of communication devices, that is a more specific example in FIG. 2;

FIG. 4 is a conceptual diagram for describing a method of transferring traffic to a plurality of communication paths of a communication network in consideration of an availability of a wireless link according to an example embodiment of the present invention;

FIG. 5 is a conceptual diagram for describing a method of transferring traffic to a plurality of communication paths of a communication network according to the background art;

FIG. 6 is a block diagram illustrating a wireless network according to a first example embodiment of the present invention to which the availability calculation device illustrated in FIG. 1 is applied;

FIG. 7 is a link band frequency distribution table and an availability calculation table for a wireless link, and a graph illustrating a link band histogram and an availability distribution of the wireless link according to an example embodiment of the present invention;

FIG. 8A is a conceptual diagram illustrating an example of a frame format that is a frame format including ETH-BN information and can be discriminated by a communication device included in a network;

FIG. 8B is a conceptual diagram illustrating an example of a frame format that is a frame format including bandwidth notification information and can be determined by the communication device included in the network;

FIG. 9 is a block diagram illustrating a wireless network according to a second example embodiment of the present invention to which the availability calculation device illustrated in FIG. 1 is applied; and

FIG. 10 is a block diagram for describing an example of a configuration of a communication device that implements an L3 communication device in FIG. 6 or an L2 wireless communication device in FIG. 9.

### EXAMPLE EMBODIMENT

### Outline of Present Invention

In the present invention, new indexes representing the reliability of a wireless link and a calculation method thereof in a communication network including the wireless link will be described. The new indexes are two indexes such as an availability of a wireless link and a highly reliable bandwidth of the wireless link. Finally, the highly reliable bandwidth of the wireless link that is the new index is used for a path selection process in a communication device exemplified in the L3 (Layer 3) communication device, and thus high priority traffic can be transferred to a high reliability path more reliably than in the background art.

### Example Embodiment of Superordinate Concept

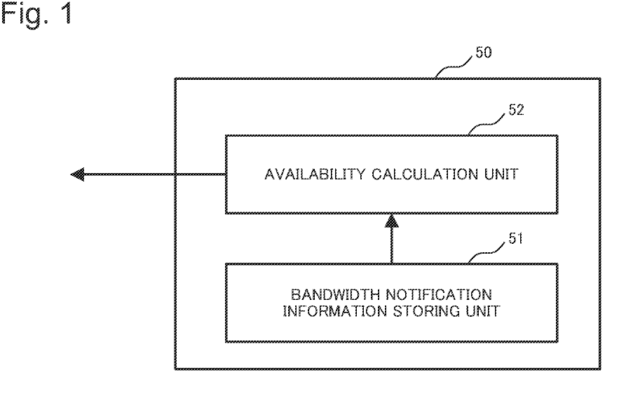

Prior to description of a specific example embodiment according to the present invention, an availability calculation device and an availability calculation method according to an example embodiment of a superordinate concept will be described. FIG. 1 is a block diagram illustrating an availability calculation device according to an example embodiment of a superordinate concept of the present invention.

An availability calculation device 50 in FIG. 1 is provided in a communication device of a communication network including a plurality of communication paths formed by a plurality of communication devices. The availability calculation device 50 in FIG. 1 includes a bandwidth notification information storing unit 51 that stores bandwidth notification information received from another communication device included in the communication network for a certain period, and an availability calculation unit 52 that calculates an availability for each bandwidth of a wireless link by using the bandwidth notification information stored in the bandwidth notification information storing unit 51.

The bandwidth notification information storing unit 51 receives the bandwidth notification information regarding a wireless link from a communication device connected to the wireless link, and stores the received bandwidth notification information for a certain period. The availability calculation unit 52 calculates an availability for each bandwidth of the wireless link by using the bandwidth notification information stored in the bandwidth notification information storing unit 51. In the above-described way, a bandwidth with a high availability can be recognized for each bandwidth of a wireless link. Preferably, the availability calculation unit 52 derives a highly reliable bandwidth based on the calculated availability for each bandwidth of the wireless link.

According to the availability calculation device 50 in FIG. 1, it is possible to provide a new index used to determine a transfer destination of traffic in consideration of information regarding the derived highly reliable bandwidth. By determining the transfer destination of the traffic by using this new index, it is possible to solve the issue of transferring high priority traffic to a wireless link having a relatively low availability in a communication network including a plurality of communication paths formed by a plurality of communication devices, and to suppress the occurrence of a loss of the high priority traffic. Consequently, it is possible to transfer traffic in consideration of an availability of a wireless link in a communication path of the communication network including the plurality of communication paths formed by the plurality of communication devices. Hereinafter, more specific example embodiments of the present invention will be described.

### Communication Network to Which Present Invention is Applied

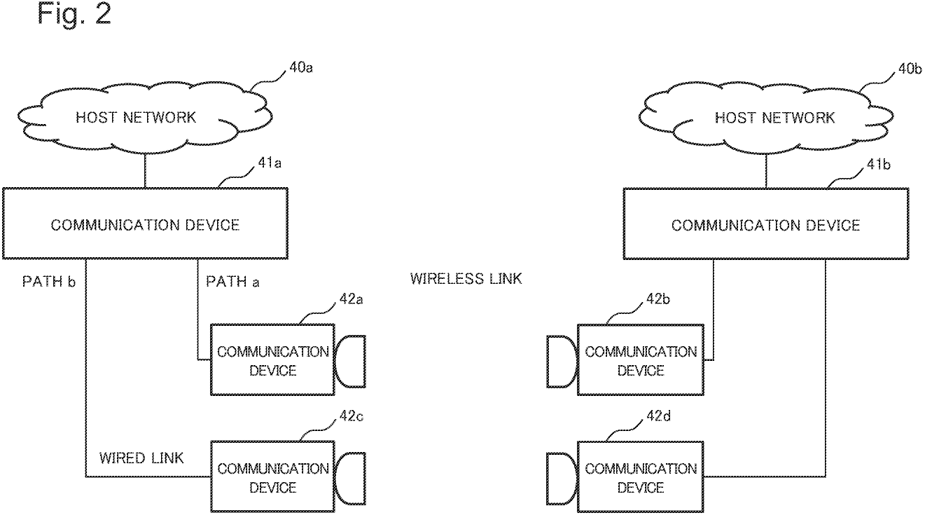

FIG. 2 is a block diagram for describing an example of a communication network including a plurality of communication paths formed by a plurality of communication devices to which the availability calculation device in FIG. 1 is applied.

The communication network in FIG. 2 includes a plurality of communication devices such as communication devices 41a and 41b and communication devices 42a, 42b, 42c, and 42d, and a plurality of communication paths are formed by these communication devices. The communication device 42a and the communication device 42b in FIG. 2 are connected via a wireless link, and the communication device 42c and the communication device 42d are connected via a wireless link. The communication device 41a and the communication device 42a, and the communication device 41a and the communication device 42c in FIG. 2 are connected via wired links. The communication device 41b and the communication device 42b, and the communication device 41b and the communication device 42d in FIG. 2 are connected via the wired links. The communication device 41a is connected to a host network 40a, and the communication device 41b is connected to a host network 40b.

In the communication network in FIG. 2, the communication device 41a and the communication device 41b that is an opposite communication device of the communication device 41a are connected via a plurality of communication paths such as a path a including the communication device 42a, the wireless link, and the communication device 42b and a path b including the communication device 42c, the wireless link, and the communication device 42d. When transferring traffic to the communication device 41b that is the opposite communication device, the communication device 41a determines a transfer destination of the traffic from among the plurality of communication paths.

Among the communication devices included in the communication network in FIG. 2, for example, the communication device 41a, the communication device 42a, or the communication device 42b includes the above-described availability calculation device in FIG. 1, and thus a bandwidth with high availability for each bandwidth of the wireless link can be recognized. Preferably, the availability calculation unit 52 derives a highly reliable bandwidth based on a calculated availability for each bandwidth of the wireless link. In consideration of information regarding the highly reliable bandwidth derived in the above-described way, the communication device 41a determines the transfer destination of the traffic for the plurality of communication paths.

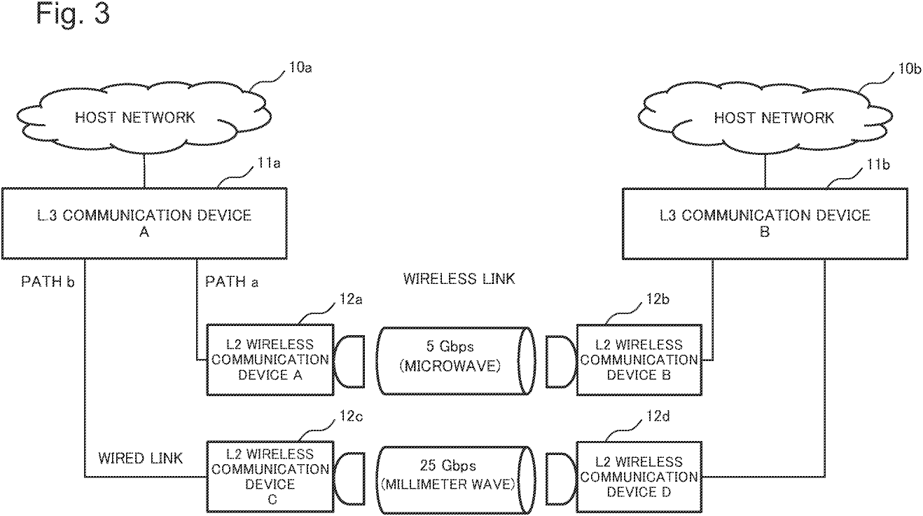

FIG. 3 is a block diagram for describing an example of a communication network including a plurality of communication paths formed by a plurality of communication devices, which is a more specific example of FIG. 2. FIG. 3 illustrates a configuration example in a case where the communication network in FIG. 2 is Ethernet.

The communication network in FIG. 3 includes a plurality of communication devices such as an L3 (Layer 3) communication device A (L3 communication device 11a), an L3 communication device B (L3 communication device 11b), an L2 (Layer 2) wireless communication device A (L2 wireless communication device 12a), an L2 wireless communication device B (L2 wireless communication device 12b), an L2 wireless communication device C (L2 wireless communication device 12c), and an L2 wireless communication device D (L2 wireless communication device 12d), and a plurality of communication paths is formed by these communication devices.

The L2 wireless communication device A and the L2 wireless communication device B in FIG. 3 are connected via a wireless link, and the L2 wireless communication device C and the L2 wireless communication device D are connected via a wireless link. FIG. 3 illustrates, as an example, a case where a 5 Gbps microwave as an example of a microwave in a relatively low frequency band is used as a carrier wave of the wireless link between the L2 wireless communication device A and the L2 wireless communication device B. FIG. 3 illustrates, as an example, a case where a millimeter wave of 25 Gbps as an example of a millimeter wave in a relatively high frequency band is used as a carrier wave of the wireless link between the L2 wireless communication device C and the L2 wireless communication device D.

The L3 communication device A and the L2 wireless communication device A in FIG. 3 are connected via a wired link, and the L3 communication device A and the L2 wireless communication device C are connected via a wired link. The L3 communication device B and the L2 wireless communication device B, and the L3 communication device B and the L2 wireless communication device D in FIG. 3 are connected via wired links. The L3 communication device A (L3 communication device 11a) is connected to a host network 10a, and the L3 communication device B (L3 communication device 11b) is connected to a host network 10b.

In the communication network in FIG. 3, the L3 communication device A and the L3 communication device B that is an opposite communication device of the L3 communication device A are connected via a plurality of communication paths such as a path a including the L2 wireless communication device A, the wireless link, and the L2 wireless communication device B, and a path b including the L2 wireless communication device C, the wireless link, and the L2 wireless communication device D. When transferring traffic to the L3 communication device B that is an opposite communication device, the L3 communication device A determines a transfer destination of the traffic from among the plurality of communication paths.

Among the communication devices included in the communication network in FIG. 3, for example, the L3 communication device A, or the L2 wireless communication device A or the L2 wireless communication device C includes the above-described availability calculation device in FIG. 1, and thus a bandwidth with high availability for each bandwidth of the wireless link can be recognized. Preferably, the availability calculation unit 52 derives a highly reliable bandwidth based on a calculated availability for each bandwidth of the wireless link. In consideration of the information of the highly reliable bandwidth derived in the above-described way, the L3 communication device A determines the transfer destination of the traffic for the plurality of communication paths.

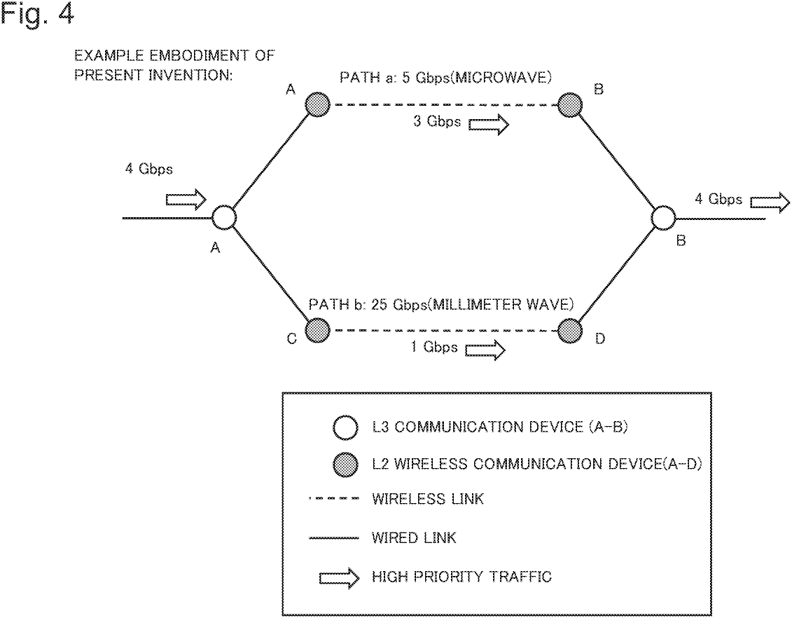

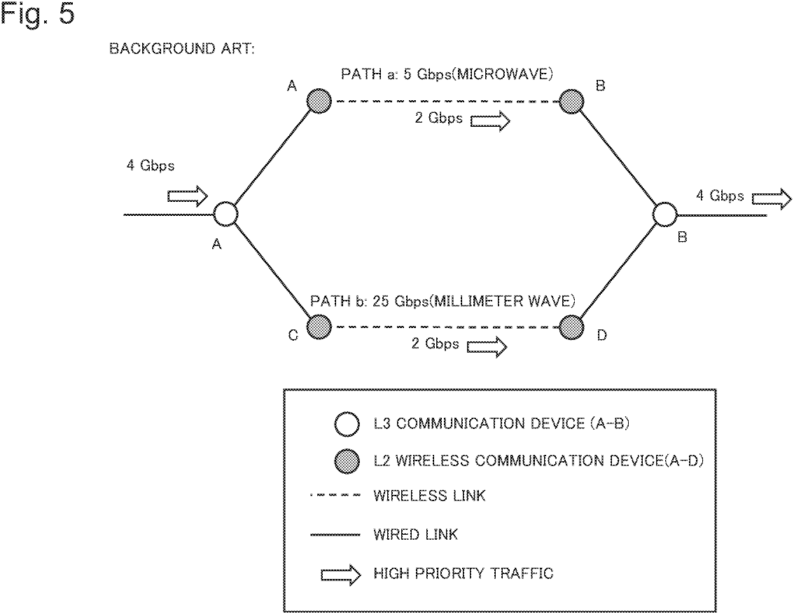

Hereinafter, a detailed description will be made with reference to FIG. 3 and the like. FIG. 4 is a conceptual diagram for describing a method of transferring traffic to a plurality of communication paths of a communication network in consideration of an availability of a wireless link according to an example embodiment of the present invention. FIG. 5 is a conceptual diagram for describing a method of transferring traffic to a plurality of communication paths of a communication network according to the background art.

In FIGS. 4 and 5, it is assumed that a high availability bandwidth of the path a is 3 Gbps, and a high availability bandwidth of the path b is 1 Gbps. In FIGS. 4 and 5, “o” (white circle) represents an L3 communication device (L3 communication devices A and B) in FIG. 3, and “•” (black circle) represents an L2 wireless communication device (L2 wireless communication devices A, B, C, and D) in FIG. 3. In FIGS. 4 and 5, a dotted line represents a wireless link, a solid line represents a wired link, and an arrow represents high priority traffic.

In FIG. 3, it is assumed that wireless links connecting two L3 communication devices A and B are present in two paths (the path a and the path b) due to four L2 wireless communication devices A, B, C, and D (two opposite communication devices).

Here, it is assumed that a microwave in a relatively low frequency band is used as a carrier wave of the wireless link of the path a, and a millimeter wave in a relatively high frequency band is used as a carrier wave of the wireless link of the path b. In this case, the link quality is considered to be higher in the path a than in the path b (refer to <Background 1> of the background art described above).

As a precondition, it is assumed that potentially high availability bandwidths of paths a and b are 3 Gbps and 1 Gbps, respectively. In other words, as a precondition, it is assumed that the high availability bandwidths of the paths a and b that can be derived in a case where the example embodiment of the present invention is applied are 3 Gbps and 1 Gbps, respectively. That is, the path a can transfer traffic of up to 3 Gbps with high quality. In other words, the path a can transfer traffic of up to 3 Gbps with high availability. On the other hand, the path b can transfer only traffic up to 1 Gbps with high quality (high availability).

Under the above circumstances, a case where the L3 communication device A transfers high priority traffic of 4 Gbps to the opposite L3 communication device B will be considered. It is assumed that the paths a and b are equivalent costs on the L3 routing protocol.

First, considering a background case to which the example embodiment of the present invention is not applied, the L3 communications device A cannot recognize potential high availability bandwidths of the paths a and b. Therefore, in the background art, as illustrated in FIG. 5, the high priority traffic of 4 Gbps from the host network to the L3 communication device A is uniformly transferred to the paths a and b. In this case, in the path b, high priority traffic of 2 Gbps potentially flows through a link having the high availability bandwidth of 1 Gbps. In this situation, since the high priority traffic flowing through the path b exceeds the high availability bandwidth of the path b, there is concern that a loss may occur in the high priority traffic transferred to the path b in a case where the quality (bandwidth) of the path b temporarily decreases. On the other hand, in the path a, since the high priority traffic flowing through the path a does not exceed the high availability bandwidth of the path a, the concern is smaller than that of the path b.

Next, considering a case where the example embodiment of the present invention is applied, in the present example embodiment, the L3 communication device A can recognize the high availability bandwidths of the paths a and b. Consequently, as illustrated in FIG. 4, the high priority traffic of 4 Gbps is transferred within the high availability bandwidth as much as possible. In this case, the high priority traffic of 4 Gbps may be transferred as 3 Gbps to the path a and 1 Gbps to the path b. Therefore, since the high priority traffic can be transferred within the high availability bandwidths of the paths a and b, the concern that a loss of the high priority traffic may occur is reduced in the example embodiment of the present invention compared with the background art.

### First Example Embodiment

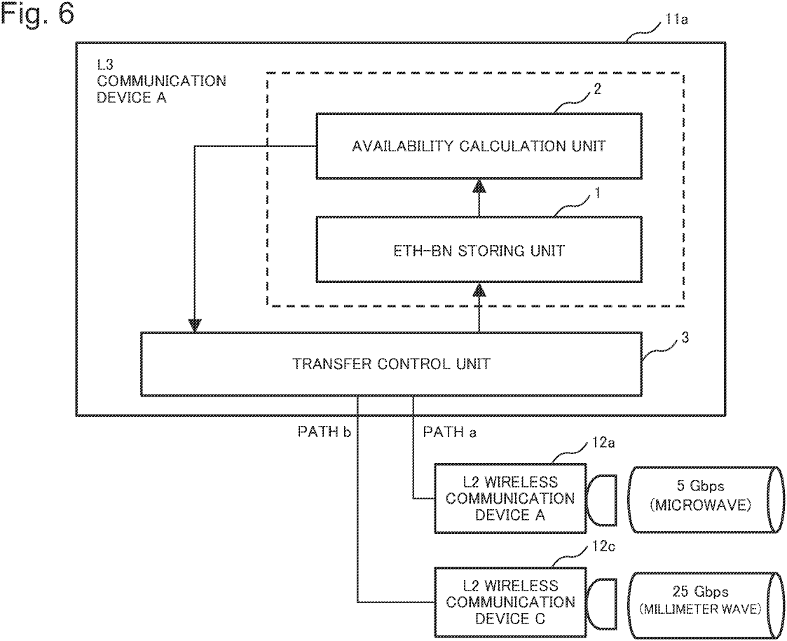

Next, a communication device according to a first example embodiment of the present invention, a communication network including a plurality of communication paths formed by a plurality of communication devices, and the like will be described. FIG. 6 is a block diagram for describing a wireless network according to a first example embodiment of the present invention to which the availability calculation device illustrated in FIG. 1 is applied.

### Configuration of Example Embodiment

FIG. 6 corresponds to a detail of a part of the configuration in FIG. 3. In FIG. 6, the L3 communication device B, the L2 wireless communication device B, and the L2 wireless communication device D, which are opposite communication devices illustrated in FIG. 3, are not illustrated.

In the same manner as in FIG. 3, the wireless network in FIG. 6 includes a plurality of communication devices such as the L3 communication device A (L3 communication device 11a), the L2 wireless communication device A (L2 wireless communication device 12a), and the L2 wireless communication device C, and a plurality of communication paths are formed by these communication devices. The L2 wireless communication device A in FIG. 6 and the L2 wireless communication device B (not illustrated) are connected via a wireless link, and the L2 wireless communication device C and the L2 wireless communication device D (not illustrated) are connected via a wireless link.

A communication device such as the L3 communication device A of the present example embodiment originally includes a transfer control unit 3. The transfer control unit 3 determines a path to which traffic received from another device is to be transferred. The L3 communication device A according to the example embodiment of the present invention includes an ETH-BN storing unit 1 as an example of a bandwidth notification information storing unit that stores received bandwidth notification information for a certain period, and an availability calculation unit 2. Here, ETH-BN stands for Ethernet Bandwidth Notification. The L3 communication device A receives an ETH-BN message as an example of a bandwidth notification message from the L2 wireless communication device A and the L2 wireless communication device C. The ETH-BN storing unit 1 stores the ETH-BN information received by the L3 communication device A for a certain period (the unit is protocol data unit (PDU)). The availability calculation unit 2 calculates an availability for each link bandwidth by using the ETH-BN information stored in the ETH-BN storing unit 1. The availability calculation unit 2 derives a highly reliable bandwidth based on the calculated availability. Thereafter, the transfer control unit 3 is notified of information regarding the highly reliable bandwidth derived by the availability calculation unit 2. An operation of each unit will be described in detail below (operation of example embodiment).

In the above configuration example, the L3 communication device A includes the ETH-BN storing unit 1 and the availability calculation unit 2. However, the example embodiment of the present invention is not limited to the configuration in which the ETH-BN storing unit 1 and the availability calculation unit 2 are included in the L3 communication device. An example in which the ETH-BN storing unit 1 and the availability calculation unit 2 are included in an L2 wireless communication device will be described later as a second example embodiment of the present invention.

### Bandwidth Notification Information

As bandwidth notification information according to the example embodiment of the present invention, bandwidth notification information in a frame format that can be determined by a communication device included in a communication network, or ETH-BN information of Ethernet may be used.

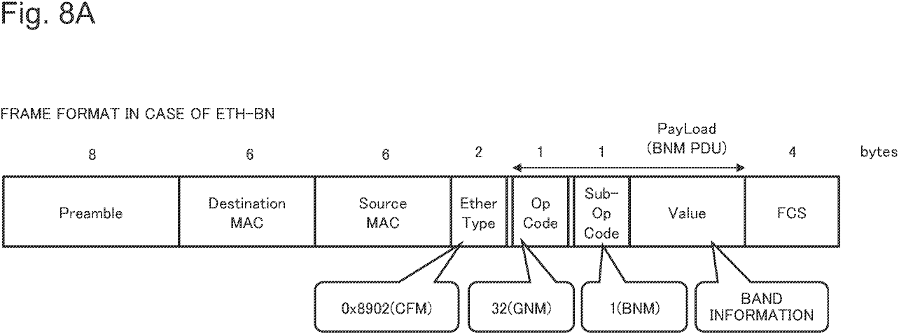

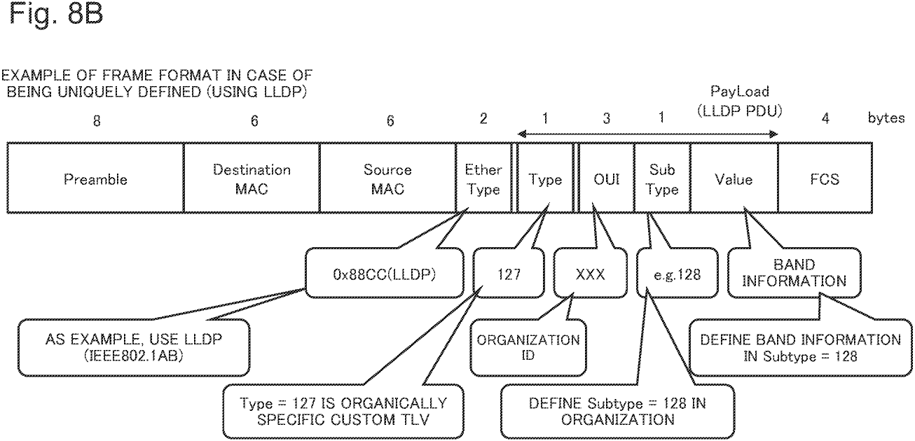

Here, a case where the bandwidth notification information is ETH-BN information of Ethernet will be described. FIG. 8A is a conceptual diagram illustrating an example of a frame format that is a frame format including ETH-BN information and can be determined by a communication device included in a network. Chapter 9.25 of the above NPL1 discloses a Bandwidth Notification Massage Protocol Data Unit (BNM PDU) format.

The frame format in FIG. 8A includes Preamble, Destination MAC, Source MAC, EtherType, OpCode, Sub-OpCode, Value, and FCS, and reported bandwidth information is described in Value. Here, the abbreviation in FIG. 8A indicates the following.
CFM: Connectivity Fault Management
GNM: Generic Notification Message
BNM: Bandwidth Notification Message

The band information to be reported is not limited to ETH-BN information of Ethernet, and a method of reporting a band with a uniquely defined protocol is also conceivable. A method of reporting a band with a uniquely defined protocol will be described later.

### Operation of Example Embodiment

Next, an operation of the present example embodiment, that is, an availability calculation method, a traffic transfer destination determination method, and the like will be described.

### Flow of Operation

(1) First, the L2 wireless communication device A or the L2 wireless communication device C periodically transmits an ETH-BN to the L3 communication device A. The L3 communication device A receives the ETH-BN from the L2 wireless communication device A or the L2 wireless communication device C.
(2) The L3 communication device A stores the received ETH-BN in the ETH-BN storing unit 1 for a certain period. Here, a storing period of the ETH-BN is defined as T_{BN} (PDU).
(3) In the L3 communication device A, the availability calculation unit 2 calculates an availability for each bandwidth of a wireless link by using the ETH-BN information stored in the ETH-BN storing unit 1. The availability calculation unit 2 derives a highly reliable bandwidth based on the calculated availability for each link bandwidth. A method of calculating an availability and a method of deriving a highly reliable bandwidth will be described in <Method of calculating availability of wireless link> below.
(4) The L3 communication device A notifies the transfer control unit 3 of information regarding the highly reliable bandwidth derived by the availability calculation unit 2.
(5) The L3 communication device A takes into consideration the information regarding the highly reliable bandwidth reported from the availability calculation unit 2 when determining a transfer destination of traffic in the processing of the transfer control unit 3. Specifically, the high priority traffic is preferentially transferred by using the highly reliable bandwidth. However, the logic of a transfer destination determination process in the transfer control unit 3 is outside the scope of the present invention, and an existing technique can be used.

### Method of Calculating Availability of Wireless Link

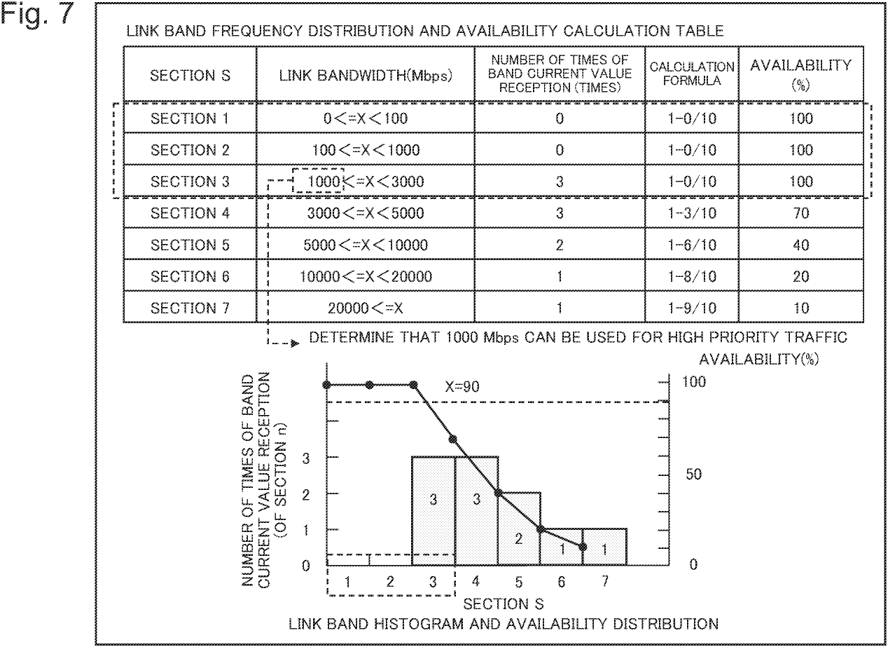

Next, an availability calculation method will be described more specifically. The availability calculation unit 2 derives an availability and a highly reliable bandwidth of a wireless link according to the following procedure. The availability calculation unit 2 includes a frequency distribution and an availability calculation table for a link band. An example of a frequency distribution and an availability calculation table for a link band is illustrated in FIG. 7. In FIG. 7, as supplementary information, a link band histogram and availability distribution created based on a link band frequency distribution table and availability calculation table are also illustrated.
I. A link band current value (Current Bandwidth) is acquired from the ETH-BN information in the ETH-BN storing unit 1.
II. The acquired T_{BN} link band current values (in FIG. 7, T_{BN} = 10) are filled in the link band frequency distribution table (the number of times of band current value reception (times)).
III. In each section S (in FIG. 7, a natural number of 0 < S < = 7) of the link band frequency distribution table, an availability Aₛ of each section S is calculated as in the following equation.

$${\text{A}}_{\text{S}} = \text{1 -} \left({\text{U}}_{\text{s}} / {\text{T}}_{\text{BN}}\right)$$

Here, Us represents the number of ETH-BNs in which the link band current value is smaller than a lower limit value of a link band range of the section S among ETH-BNs stored in the ETH-BN storing unit 1. In FIG. 7, since there is no ETH-BN in which the link band current value is smaller than the lower limit value “1000 Mbps” of the band range of the section S = 3, that is, there is no ETH-BN corresponding to the band range of the sections S = 1 and 2, Us = 0 is obtained as follows.

$${\text{A}}_{\text{3}} \text{=1 -} \left(\text{0} / 10\right) \text{= 1} \left({\text{= A}}_{\text{1}} {\text{= A}}_{\text{2}}\right)$$

On the other hand, since there are three ETH-BNs below the lower limit value “3000 Mbps” of the band range of the section S = 4, Us = 3 is obtained as follows.

$${\text{A}}_{\text{4}} \text{=} 1 \text{-} \left(3 / 10\right) \text{=} 0.7$$

IV. A highly reliable bandwidth to be preferentially used for transferring high priority traffic is determined based on the availability AS of each section S. Any high availability threshold value X is set. FIG. 7 illustrates a case where X = 0.9, that is, the high availability threshold value is set to 90%.

Here, a lower limit value of a bandwidth of the section S having the maximum S satisfying the following condition is determined as a highly reliable bandwidth. In FIG. 7, it is determined that the highly reliable bandwidth is 1000 Mbps that is the lower limit value of the link bandwidth in the section S = 3.

$${\text{X <= A}}_{\text{S}}$$

### Description of Advantageous Effect

According to the communication device and the communication network of the present example embodiment, similarly to the above example embodiment, traffic can be transferred in consideration of an availability of a wireless link in a communication path of a communication network including a plurality of communication paths formed by a plurality of communication devices.

According to the communication device and the communication network of the present example embodiment, the L3 communication device can recognize a high availability bandwidth of each path. Consequently, a path can be selected in such a way as to transfer high priority traffic within a high availability bandwidth as much as possible. As a result, according to the communication device and the communication network of the present example embodiment, it is possible to suppress the occurrence of a loss of high priority traffic compared with the background art.

According to the communication device and the communication network of the present example embodiment, for example, the L3 communication device A can select a transfer path for high priority traffic in consideration of the reliability of a link based on a difference in a frequency of a wireless link included in an L2 wireless communication device (the L2 wireless communication device A or the L2 wireless communication device C). The L3 communication device B can select a transfer path for high priority traffic in consideration of the reliability of a link based on a difference in a frequency of a wireless link included in an L2 wireless communication device (the L2 wireless communication device B or the L2 wireless communication device D). Consequently, it is possible to provide a way for a provider of communication networks to design a communication network satisfying high-level SLA.

### Second Example Embodiment

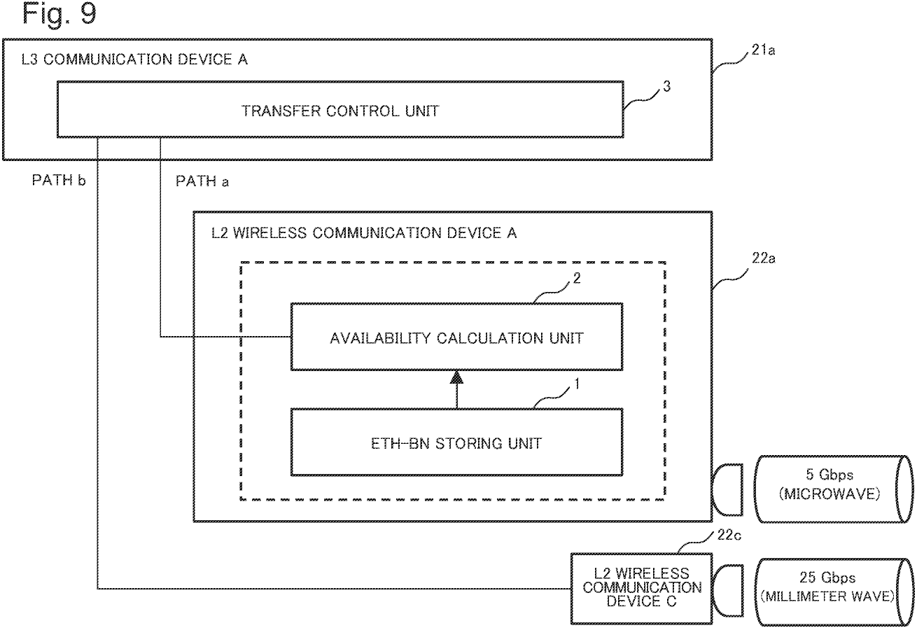

Next, a communication device according to a second example embodiment of the present invention, a communication network including a plurality of communication paths formed by a plurality of communication devices, and the like will be described. In the first example embodiment described above, it has been described that the ETH-BN storing unit and the availability calculation unit are included in the L3 communication device. However, the present invention is not limited to such a configuration. It is also conceivable that the L2 wireless communication device includes the ETH-BN storing unit and the availability calculation unit. FIG. 9 is a block diagram for describing a wireless network according to the second example embodiment of the present invention to which the availability calculation device illustrated in FIG. 1 is applied.

### Configuration of Example Embodiment

Similarly to the first example embodiment described above, FIG. 9 corresponds to a detail of a part of the configuration in FIG. 3. In FIG. 9, the L3 communication device B, the L2 wireless communication device B, and the L2 wireless communication device D, which are opposite communication devices illustrated in FIG. 3, are not illustrated.

In the same manner as in FIG. 3, the wireless network in FIG. 9 includes a plurality of communication devices such as the L3 communication device A (L3 communication device 11a), the L2 wireless communication device A (L2 wireless communication device 12a), and L2 wireless communication device C, and a plurality of communication paths are formed by these communication devices. The L2 wireless communication device A in FIG. 9 and the L2 wireless communication device B (not illustrated) are connected via a wireless link, and the L2 wireless communication device C and the L2 wireless communication device D (not illustrated) are connected via a wireless link.

The L3 communication device A of the present example embodiment includes the transfer control unit 3 in the same manner as in the first example embodiment described above. The transfer control unit 3 determines a path to which traffic received from another device is to be transferred.

In the wireless network of the first example embodiment described above, the L3 communication device A includes the ETH-BN storing unit 1 and the availability calculation unit 2, whereas in the wireless network in FIG. 9, the L2 wireless communication device (the L2 wireless communication device A or the L2 wireless communication device C) includes the ETH-BN storing unit 1 and the availability calculation unit 2. FIG. 9 illustrates a state in which the L2 wireless communication device A includes the ETH-BN storing unit 1 and the availability calculation unit 2, and does not illustrate the ETH-BN storing unit 1 and the availability calculation unit 2 of the L2 wireless communication device C.

There is no difference in a method of deriving an availability and a highly reliable bandwidth between the first example embodiment illustrated in FIG. 6 and the present example embodiment illustrated in FIG. 9, but a location (device) including the invention unit and details (protocol) of a message reported from the L2 wireless communication device to the L3 communication device are different.

### Operation of Example Embodiment

Next, an operation of the present example embodiment, that is, an availability calculation method, a traffic transfer destination determination method, and the like will be described. Detailed description of operations similar to those in the first example embodiment will be omitted.

In the same manner as in the first example embodiment, the transfer control unit 3 of the L3 communication device A determines a path to which traffic received from the other device is to be transferred. The L2 wireless communication device A or the L2 wireless communication device B of the present example embodiment includes an ETH-BN storing unit 1 and an availability calculation unit 2. As in the first example embodiment, the ETH-BN storing unit 1 of the L2 wireless communication device A stores ETH-BN information received by the L2 wireless communication device A for a certain period (the unit is PDU). The availability calculating unit 2 of the L2 wireless communication device A calculates an availability for each link bandwidth in the same manner as in the first example embodiment by using the ETH-BN information stored in the ETH-BN storing unit 1. In addition, similarly to the first example embodiment, the availability calculation unit 2 of the L2 wireless communication device A derives the highly reliable bandwidth based on the calculated availability.

Thereafter, the L2 wireless communication device A notifies the transfer control unit 3 of the L3 communication device A of the information regarding the highly reliable bandwidth derived by the availability calculation unit 2. In this case, in the present example embodiment, the information regarding the highly reliable bandwidth is stored and transmitted in a message format with a uniquely defined protocol. Specifically, a value stored in an Ether Type field of the Ethernet frame is changed. A protocol will be uniquely defined as a product specification of a device that implements the present invention.

Although not illustrated, the L2 wireless communication device C of the present example embodiment also includes an ETH-BN storing unit and an availability calculation unit. Also in the L2 wireless communication device C, the ETH-BN storing unit stores the ETH-BN information received by the L2 wireless communication device C for a certain period (the unit is PDU). The availability calculation unit of the L2 wireless communication device C calculates an availability for each link bandwidth by using the ETH-BN information stored in the ETH-BN storing unit. The availability calculation unit of the L2 wireless communication device C derives a highly reliable bandwidth based on the calculated availability. Thereafter, the L2 wireless communication device C notifies the transfer control unit 3 of the L3 communication device A of information regarding the highly reliable bandwidth derived by the availability calculation unit. In this case, similarly to the L2 wireless communication device A, the information regarding the highly reliable bandwidth is stored and transmitted in the message format of the uniquely defined protocol.

A method of calculating an availability of a wireless link by the availability calculation unit of the L2 wireless communication device is similar to <Method of calculating availability of wireless link> of the first example embodiment described above, and thus the description thereof will be omitted.

### Flow of Operation

(1) The L2 wireless communication device (the L2 wireless communication device A or the L2 wireless communication device C) periodically generates an ETH-BN in the L2 wireless communication device, and stores the ETH-BN in the ETH-BN storing unit 1 for a certain period. A storing period of the ETH-BN is defined as TBN (PDU).
(2) In the L2 wireless communication device (the L2 wireless communication device A or the L2 wireless communication device C), the availability calculation unit 2 calculates an availability for each bandwidth of the wireless link by using the ETH-BN information stored in the ETH-BN storing unit 1. The availability calculation unit 2 derives a highly reliable bandwidth based on the calculated availability for each link bandwidth. A method of calculating an availability and a method of deriving a highly reliable bandwidth are as described in the above <Method of calculating availability of wireless link>.
(3) The L2 wireless communication device (the L2 wireless communication device A or the L2 wireless communication device C) notifies the L3 communication device A of information regarding the highly reliable bandwidth derived by the availability calculation unit 2. In this case, a uniquely defined message format (protocol) is used for a notification.
(4) When determining a transfer destination of traffic in the processing of the transfer control unit 3, the L3 communication device A takes into consideration the information regarding the highly reliable bandwidth reported from the L2 wireless communication device (the L2 wireless communication device A or the L2 wireless communication device C). Specifically, the high priority traffic is preferentially transferred by using the highly reliable bandwidth. However, the logic of a transfer destination determination process in the transfer control unit 3 is outside the scope of the present invention, and an existing technique can be used.

### Description of Advantageous Effect

According to the communication device and the communication network of the present example embodiment, similarly to the above example embodiment, traffic can be transferred in consideration of an availability of a wireless link in a communication path of a communication network including a plurality of communication paths formed by a plurality of communication devices.

According to the communication device and the communication network of the present example embodiment, the L3 communication device can recognize a high availability bandwidth of each path. Consequently, a path can be selected in such a way as to transfer high priority traffic within a high availability bandwidth as much as possible. As a result, according to the communication device and the communication network of the present example embodiment, it is possible to suppress the occurrence of a loss of high priority traffic compared with the background art.

According to the communication device and the communication network of the present example embodiment, in the same manner as in the first example embodiment described above, the L3 communication device A can select a transfer path for high priority traffic in consideration of the reliability of a link based on a difference in a frequency of a wireless link included in an L2 wireless communication device (the L2 wireless communication device A or the L2 wireless communication device C). The L3 communication device B can select a transfer path for high priority traffic in consideration of the reliability of a link based on a difference in a frequency of a wireless link included in an L2 wireless communication device (the L2 wireless communication device B or the L2 wireless communication device D). Consequently, it is possible to provide a way for a provider of communication networks to design a communication network satisfying high-level SLA.

According to the present example embodiment, the L2 wireless communication device (the L2 wireless communication device A or the L2 wireless communication device C) employs a unique protocol, and thus the L2 wireless communication device can include the ETH-BN storing unit 1 and the availability calculation unit 2. As a result, according to the present example embodiment, the degree of freedom of a configuration of a communication system can be improved.

Although the preferred example embodiments of the present invention have been described above, the present invention is not limited thereto. Needless to say, various modifications are possible within the scope of the invention disclosed in the claims, and they are also included in the scope of the present invention.

In the above example embodiments, a case where the communication network is Ethernet and the band information to be reported is ETH-BN information has been mainly described, but the present invention is not limited thereto. The band information to be reported is not limited to ETH-BN information of Ethernet, and bandwidth notification information in a frame format discriminable by a communication device included in a communication network may be used. A notification of the band information can be achieved, for example, by using a frame format that is uniquely defined and that can be determined by the communication device included in the communication network. FIG. 8B is a conceptual diagram illustrating an example of a frame format that is a frame format including bandwidth notification information and can be determined by a communication device included in a network.

FIG. 8B illustrates an example of a frame format assuming a case where band information is transmitted as a part of information of LLDP (IEEE 802.1 ab) that is another protocol. In the case of a Link Layer Discovery Protocol (LLDP), Type = 127 of the Link Layer Discovery Protocol Type Length Value (LLDP TLV) is a custom Type Length Value (TLV) in which an Organizationally Specific definition is possible, and in the Type Length Value, an Organizationally defined subtype can be defined for each organization. For example, in a case where a communication device vendor uniquely defines Organizationally defined subtype = 128, defines the Protocol Data Unit (PDU) format to include band information, and installs the PDU format in a device, it is possible to provide a notification of the band information even if it is not an ETH-BN as illustrated in FIG. 8A.

The frame format in FIG. 8B includes Preamble, Destination MAC, Source MAC, EtherType, Type, OUI, SubType, Value, and FCS, and bandwidth information to be reported is described in Value. Here, in FIG. 8B, the Organizationally defined subtype is denoted as SubType, and the abbreviation in FIG. 8B indicates the following.
LLDP: Link Layer Discovery Protocol
OUI: Organizationally unique identifier

A communication network to which the present invention is applied is not limited to Ethernet, and the present invention can also be applied to a communication network other than Ethernet. For example, the present invention can also be applied to a point-to-point protocol (PPP) by defining a unique protocol that enables bandwidth notification.

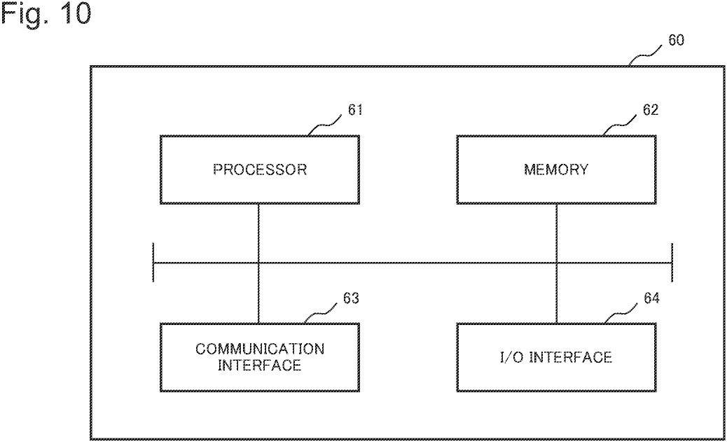

The L3 communication device 11a or the L2 wireless communication device 22a described in the above example embodiments can be implemented by a communication device including a processor such as a central processing unit (CPU) or a micro-processing unit (MPU) and a memory. FIG. 10 is a block diagram for describing an example of a configuration of a communication device that implements the L3 communication device 11a in FIG. 6 or the L2 wireless communication device 22a in FIG. 9. A communication device 60 in FIG. 10 includes a processor 61 typified by a CPU or an MPU, and a memory 62 typified by a random access memory (RAM) or a read only memory (ROM). The communication device 60 in FIG. 10 further includes a communication interface 63, an input/output (I/O) interface 64, and the like.

The communication interface 63 of the communication device 60 is an interface for communicating with an opposite communication device or the like. The I/O interface 64 is an interface for an operator or a manager of the communication device 60 to operate the communication device 60 or to extract information.

Functions such as a bandwidth notification information storing function of storing received bandwidth notification information for a certain period and an availability calculation function of calculating an availability for each bandwidth of a wireless link by using the bandwidth notification information stored by the bandwidth notification information storing function can also be achieved by reading a program to the communication device 60 including the processor 61 and the memory 62 in FIG. 10 and executing the program.

Such a program may be distributed in a form of a recording medium in which the program is recorded. This program may be distributed in a form of a general-purpose semiconductor recording device such as a Compact Flash (Registered Trademark) (CF) and a Secure Digital (SD), a magnetic recording medium such as a flexible disk, an optical recording medium such as a compact disc read only memory (CD-ROM), or the like.

The whole or part of the example embodiments disclosed above can be described as, but not limited to, the following supplementary notes.

(Supplementary Note 1) An availability calculation device including:
a bandwidth notification information storing unit that stores received bandwidth notification information for a certain period; and
an availability calculation unit that calculates an availability for each bandwidth of a wireless link by using the bandwidth notification information stored in the bandwidth notification information storing unit.

(Supplementary Note 2) The availability calculation device according to Supplementary Note 1, in which
the availability calculation unit calculates an availability of each section of a section n (where n is a natural number exceeding 0) by using a storing period of the received bandwidth notification information stored in the bandwidth notification information storing unit and the number of pieces of bandwidth notification information in which a current value of a link band of the wireless link is less than a lower limit value of a link band range of the section n.

(Supplementary Note 3) The availability calculation device according to Supplementary Note 1 or 2, in which

the availability calculation unit derives a highly reliable bandwidth based on the calculated availability for each bandwidth of the wireless link.

(Supplementary Note 4) A communication device included in a communication network including a plurality of communication paths formed by a plurality of communication devices, the communication device including
the availability calculation device according to Supplementary Note 3, in which
the communication device determines a transfer destination of traffic in consideration of information regarding the derived highly reliable bandwidth.

(Supplementary Note 5) The communication device according to Supplementary Note 4, further including
a transfer control unit that controls a transfer destination of the traffic, in which
the transfer control unit allocates the transfer destination of the traffic in consideration of the information regarding the highly reliable bandwidth derived by the availability calculation device.

(Supplementary Note 6) A communication device included in a communication network including a plurality of communication paths formed by a plurality of communication devices, the communication device being connected to the wireless link and including

the availability calculation device according to any one of Supplementary Notes 1 to 3.

(Supplementary Note 7) The communication device according to Supplementary Note 6, in which

the communication device connected to the wireless link transmits information regarding a derived highly reliable bandwidth to a communication device that determines a transfer destination of traffic from among the communication devices included in the communication network.

(Supplementary Note 8) The communication device according to any one of Supplementary Notes 4 to 7, in which the bandwidth notification information is bandwidth notification information in a frame format discriminable by a communication device included in the communication network, or Ethernet Bandwidth Notification (ETH-BN) information of Ethernet (Registered Trademark).

(Supplementary Note 9) A communication network including a plurality of communication paths formed by a plurality of communication devices, the communication network including
the communication device according to any one of Supplementary Notes 4 to 8. (Supplementary Note 10) An availability calculation method including:
storing received bandwidth notification information for a certain period; and
calculating an availability for each bandwidth of a wireless link by using the stored bandwidth notification information.

(Supplementary Note 11) The availability calculation method according to Supplementary Note 10, further including

calculating an availability of each section of a section n (where n is a natural number exceeding 0) by using a storing period of the received bandwidth notification information that is stored and the number of pieces of bandwidth notification information in which a current value of a link band of the wireless link is less than a lower limit value of a link band range of the section n.

(Supplementary Note 12) The availability calculation method according to Supplementary Note 10 or 11, further including

deriving a highly reliable bandwidth based on the calculated availability for each bandwidth of the wireless link.

(Supplementary Note 13) A determination method for determining a transfer destination of traffic in a communication network including a plurality of communication paths formed by a plurality of communication devices, the determination method including

determining the transfer destination of the traffic in consideration of information regarding a highly reliable bandwidth derived by using the availability calculation method according to Supplementary Note 12.

(Supplementary Note 14) The determination method according to Supplementary Note 13, in which

among the communication devices included in the communication network, a communication device that determines the transfer destination of the traffic allocates the transfer destination of the traffic in consideration of the derived highly reliable bandwidth information.

(Supplementary Note 15) The determination method according to Supplementary Note 13, in which
among the communication devices included in the communication network, a communication device connected to the wireless link transmits information regarding the derived highly reliable bandwidth to a communication device that determines the transfer destination of the traffic, and
the communication device that allocates the transfer destination of the traffic allocates the transfer destination of the traffic in consideration of the derived highly reliable bandwidth information.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor’s intent is to retain all equivalents of the claimed invention even if the claims are amended during prosecution.

claim 1 An availability calculation device comprising:
a bandwidth notification information storing unit that stores received bandwidth notification information for a certain period; and
an availability calculation unit that calculates an availability for each bandwidth of a wireless link by using the bandwidth notification information stored in the bandwidth notification information storing unit.

claim 2 The availability calculation device according to claim 1, wherein
the availability calculation unit calculates an availability of each section of a section n (where n is a natural number exceeding 0) by using a storing period of the received bandwidth notification information stored in the bandwidth notification information storing unit and the number of pieces of bandwidth notification information in which a current value of a link band of the wireless link is less than a lower limit value of a link band range of the section n.

claim 3 The availability calculation device according to claim 1, wherein
the availability calculation unit derives a highly reliable bandwidth based on the calculated availability for each bandwidth of the wireless link.

claim 4 A communication device included in a communication network including a plurality of communication paths formed by a plurality of communication devices, the communication device comprising:
the availability calculation device according to claim 3, wherein
the communication device determines a transfer destination of traffic in consideration of information regarding the derived highly reliable bandwidth.

claim 5 The communication device according to claim 4, further comprising:
a transfer control unit that controls a transfer destination of the traffic, wherein
the transfer control unit allocates the transfer destination of the traffic in consideration of the information regarding the highly reliable bandwidth derived by the availability calculation device.

claim 6 A communication device included in a communication network including a plurality of communication paths formed by a plurality of communication devices, the communication device being connected to the wireless link and comprising:
the availability calculation device according to claim 1.

claim 7 The communication device according to claim 6, wherein
the communication device connected to the wireless link transmits information regarding a derived highly reliable bandwidth to a communication device that determines a transfer destination of traffic from among the communication devices included in the communication network.

claim 8 The communication device according to claim 4, wherein
the bandwidth notification information is bandwidth notification information in a frame format discriminable by a communication device included in the communication network, or Ethernet Bandwidth Notification (ETH-BN) information of Ethernet (Registered Trademark).

claim 9 The communication device according to claim 6, wherein
the bandwidth notification information is bandwidth notification information in a frame format discriminable by a communication device included in the communication network, or Ethernet Bandwidth Notification (ETH-BN) information of Ethernet (Registered Trademark).

claim 10 A communication network including a plurality of communication paths formed by a plurality of communication devices, the communication network comprising:
the communication device according to claim 4.

claim 11 A communication network including a plurality of communication paths formed by a plurality of communication devices, the communication network comprising:
the communication device according to claim 6.

claim 12 An availability calculation method comprising:
storing received bandwidth notification information for a certain period; and
calculating an availability for each bandwidth of a wireless link by using the stored bandwidth notification information.

claim 13 The availability calculation method according to claim 12, further comprising:
calculating an availability of each section of a section n (where n is a natural number exceeding 0) by using a storing period of the received bandwidth notification information that is stored and the number of pieces of bandwidth notification information in which a current value of a link band of the wireless link is less than a lower limit value of a link band range of the section n.

claim 14 The availability calculation method according to claim 12, further comprising:
deriving a highly reliable bandwidth based on the calculated availability for each bandwidth of the wireless link.

claim 15] A determination method for determining a transfer destination of traffic in a communication network including a plurality of communication paths formed by a plurality of communication devices, the determination method comprising:
determining the transfer destination of the traffic in consideration of information regarding a highly reliable bandwidth derived by using the availability calculation method according to claim 14.

claim 16 The determination method according to claim 15, wherein
among the communication devices included in the communication network, a communication device that determines the transfer destination of the traffic allocates the transfer destination of the traffic in consideration of the derived highly reliable bandwidth information.

claim 17 The determination method according to claim 15, wherein
among the communication devices included in the communication network, a communication device connected to the wireless link transmits information regarding the derived highly reliable bandwidth to a communication device that determines the transfer destination of the traffic, and
the communication device that allocates the transfer destination of the traffic allocates the transfer destination of the traffic in consideration of the derived highly reliable bandwidth information.
